(19) United States
(12) Patent Application Publication
(10) Pub. No.: US 2016/0078372 A1
(43) Pub. Date: Mar. 17, 2016

(54) SYSTEM AND METHOD OF TRIAL OCCUPANCY OF REAL ESTATE

(71) Applicant: Walid Romaya, San Diego, CA (US)

(72) Inventor: Walid Romaya, San Diego, CA (US)

(21) Appl. No.: 14/854,001

(22) Filed: Sep. 14, 2015

Related U.S. Application Data
(60) Provisional application No. 62/050,793, filed on Sep. 16, 2014.

(51) Int. Cl. G06Q 10/02

(52) U.S. Cl. CPC G06Q 10/02; G06Q 50/167

(57) ABSTRACT

A system and method to allow a buyer to reserve a trial occupancy of a residence listed for sale. The buyer submitting a letter of intent to purchase the residence at an offer price and agreeing to seller's trial occupancy conditions in order to reserve the residence. Optionally, the buyer requesting a trial occupancy as a contingent condition to purchase during contract negotiations. The buyer utilizing either a security deposit or insurance policy, or both, to cover damage to residence during the trial occupancy or seller's remedy for stay over tenancy.

### CROSS-REFERENCE TO RELATED APPLICATIONS

The present application claims the benefit of: U.S. Provisional Patent Application Ser. No. 62/050,793 filed Sep. 16, 2014 and entitled “SYSTEM AND METHOD OF TRIAL OCCUPANCY OF REAL ESTATE” hereby expressly incorporated by reference in their entirety. Furthermore, any and all priority claims identified in the Application Data Sheet, or any correction thereto, are hereby incorporated by reference under 37 C.F.R. §1.57.

### FIELD OF THE INVENTION

This invention relates generally to the field of rental/lease of real estate by means of a software application configured to provide real estate listings and ancillary support services related thereto.

### BACKGROUND

Commercial and residential purchase transactions are completed today with the support of “on-line” real estate portals and “off-line” personal relationships among real estate brokerage firms and their agents, property owners (Sellers) and prospective buyers (Buyers). Typically, the process begins with the real estate owner listing their real estate for sale with an agent associated with a brokerage firm who then lists the real estate within the multiple listing service (MLS). The MLS is then made available to multiple on-line real estate portals for potential buyers to access and view. The on-line real estate portals provide a means for sellers or real estate agents to market their real estate or listing to consumers. Thru this process, the potential buyer is informed of the specifications of the real estate listed for sale and important details necessary to make an informed purchase decision.

Moreover, after a potential buyer has identified a listing of interest they would then want to visit the property in person by taking an on-site tour of the property for sale. A walkthrough of a property may require the permission of the seller and availability of his/her selling agent. After the potential buyer has had the opportunity to inspect the property in-person and review the detailed specifications provided by the seller in the seller's disclosure documentation then the buyer has the opportunity to decide if they should make an offer to the seller. Potential buyers who are considering extending an offer may still have some buyer hesitation and concerns that may not be cured by further appraisals and inspection. For these reason, some buyers may hesitate to extend an offer. Alternatively, some properties may not show well depending on when the potential buyer schedules a tour, but may actually be very enjoyable to live in.

Consequently, there is a need in the art for a solution that addresses potential buyer's hesitation or concerns and provide a means for sellers to showcase their property in such a way as to invite potential buyers to see the property more closely and intimately then by traditional mean of viewing the home by walk-in tour of property available for sale.

### SUMMARY

In one aspect of the disclosure, a computer-implemented method of reserving real estate listings for trial occupancy. The computer-implemented method includes posting a trial occupancy invitation for offers for a residence listed in a real estate listing at a list price, wherein the trial occupancy invitation for offers comprises one or more of an availability dates, a trial occupancy fee, a residence profile, a cleaning fee, an amenities profile, and an occupancy profile. The real estate listing may be a description of a real estate listed for sale maintained in a datastore acquired from a multiple listing service syndicator. The computer-implemented method may further include receiving an offer for the trial occupancy, the trial offer comprising an occupancy date and a letter of intent, wherein the letter of intent is a non-binding commitment to purchase the residence at an offer price. The offer may further comprise a payment method and agreement to the acceptance policy. The computer-implemented method also includes reserving the residence for the occupancy date in response to the offer satisfying an acceptance policy, wherein the acceptance policy may be satisfied in response to the offer containing agreement to one or more availability dates, a trial occupancy fee, a cleaning fee, a cancellation policy, and a least one limitations or exclusions. The computer-implemented method further comprising claiming authority concerning the residence listed in a real estate listing at a list price.

In another aspect, a computer-implemented method of reserving real estate listings for trial occupancy. The computer-implemented method including identifying a residence offering for a trial occupancy in a real estate listing at a listing price. The residence listed for trial occupancy comprises one or more of an availability dates, a trial occupancy fee, a residence profile, a cleaning fee, an amenities profile, and an occupancy profile. The computer-implemented method also including transmitting an offer for the trial occupancy, the trial offer comprising an occupancy date and a letter of intent, wherein the letter of intent is a non-binding commitment to purchase the residence at an offer price; and receiving an acceptance for the trial occupancy for the residence for the occupancy date in response to the offer satisfying an acceptance policy. The acceptance policy may be satisfied in response to the offer containing agreement to one or more availability dates, a trial occupancy fee, a cleaning fee, a cancellation policy, and a least one limitation or exclusion. The offer may further comprise a payment method and agreement to the acceptance policy. The real estate listing may be a description of a real estate listed for sale maintained in a datastore. The real estate listing may be a description of a real estate listed for sale maintained in a datastore acquired from a multiple listing service syndicator.

In yet another aspect of the disclosure, a communication server in communication with a datastore. The communication server including a hardware implemented listing search module configured to receive a search request transmitted by a user of a client device, transmit the search request to the datastore in response to the received search request transmitted by the user of a client device, receive a search response from the datastore in response to the search request, and transmit the search response to the client device in response to the search response received from the datastore. The communication server also including a hardware implemented reservation module configured to receive a trial occupancy request from the client device, the trial occupancy request containing a letter of intent to purchase a residence listed for sale; and transmit a trial occupancy response to the client device, the trial occupancy response containing either an acceptance or denial condition in response to the trial occupancy request received from the client device. The communication server further including a hardware implemented transaction module configured to receive a transaction request from the client device, transmit the transaction request to a third party transaction server, receive a transaction response from the third party transaction server, transmit the transaction response to the client device. The search request may be a query for listings in the datastore enabled for trial occupancy matching a plurality of search filter selections. The search response may be a list of residences enabled for trial occupancy matching a plurality of search filter selections. The trial occupancy request may further contain an occupancy date. The trial occupancy request may further contain a deposit payment. The trial occupancy response may be accepted contingent upon satisfaction of payment conditions. The trial occupancy response may be accepted contingent upon agreement to acceptance policy containing an agreement to one or more availability dates, a trial occupancy fee, a cleaning fee, a cancellation fee, a cancellation policy, and at least one limitation or exclusion.

### BRIEF DESCRIPTION OF THE DRAWINGS

FIG. 1 is a functional block diagram of an exemplary communications network system.

FIG. 2 is a functional block diagram of an exemplary wireless communication system.

FIG. 3 is an exemplary message diagram for reserving a trial occupancy.

FIG. 4 is a flowchart for an exemplary method initiating and confirming trial occupancy by a potential buyer.

FIG. 5 is an exemplary message diagram for claiming a listing and configuring a trial occupancy.

FIG. 6 is an exemplary client listing search user interface.

FIG. 7 is a flowchart for an exemplary method of initiating and confirming trial occupancy by a seller or agent of real estate.

FIG. 8 is a flowchart for an exemplary method of initiating and confirming trial occupancy by a seller or agent of real estate.

FIG. 9 is a flowchart for an exemplary method of a post contract trial occupancy utilizing a contingent conditions deposit and a security deposit.

FIG. 10 is a flowchart for an exemplary method of a post contract trial occupancy utilizing a contingent conditions deposit and trial occupancy insurance.

FIG. 11 is a flowchart for an exemplary method of a post contract trial occupancy utilizing a contingent conditions deposit and either a security deposit or trial occupancy insurance, or both.

### DETAILED DESCRIPTION

One non-limiting advantage of the described systems and methods is the ability to search for real estate for both rental or purchase within an application running on a mobile device or a web-site that permits a potential buyer to electronically transmit a trial occupancy offer along with a letter of intent and receive a response based on the trial occupancy offer and confirm the trial occupancy agreement by means of an integrated payment transaction.

Another non-limiting advantage of the described systems and methods is the ability for a real estate owner or agent to list and be associated with the availability of real estate, define the conditions for trial occupancy, manually or programmatically review offers for trial occupancy, and reserve the real estate in response to the reviewed offers.

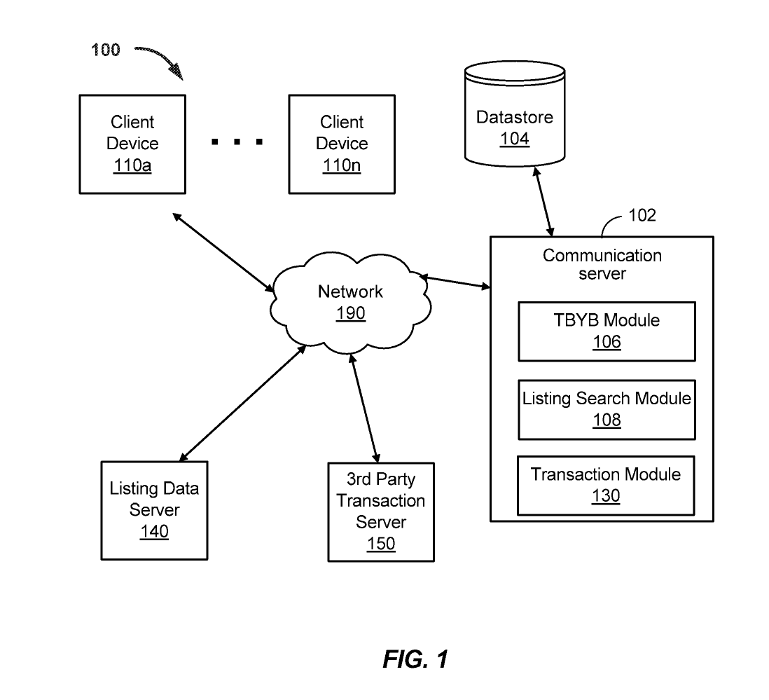

Example implementations of the systems and methods of the current disclosure are described below in further detail in connection with FIGS. 1-11.

FIG. 1 is a functional block diagram of an exemplary communications network system in accordance with one embodiment. The system 100 may be implemented via a client-server architecture where a client device has an application running locally that performs a set of functions that require communication with a server in order to support desired functionality. The client application may be configured to allow users to input their desired request of the application, after which the request is sent to the server for processing. The server may be configured to optionally archive some information (e.g., tags, user contacts information, postings, trail offer requests, claiming a listing, transaction information, etc.), and the request may be routed either back to the initiating user and/or to a target user device. The system 100 shown includes multiple client devices (e.g., a client device 110a and a client device 110n). It will be appreciated that fewer or more client devices may be included in the system 100. The client device 110a and the client device 110n (collectively or individually hereinafter referred to as “client device 110”) may be an electronic communication device configured to transmit and receive communication to and from the communication server 102. Examples of such electronic communication devices include smart phones, feature phones, laptop computers, desktop computers, tablet computers, personal digital assistants, set-top devices, gaming consoles, automotive dashboard systems, kiosks, self-service consoles, and the like.

The system 100 includes a network 190. The client device 110 may be configured to transmit and receive messages via the network 190. Examples of the network 190 include a wide area network (WAN), metropolitan area network (MAN), local area network (LAN), wireless local area network (WLAN), or personal area network (PAN). Although shown as one network, the network 190 may include several interconnected networks. The networks which may be included in the system 100 may differ according to the switching and/or routing technique used to interconnect the various network nodes and devices (e.g., circuit switching vs. packet switching), the type of physical media employed for transmission (e.g., wired vs. wireless), and the communication protocols used (e.g., Internet protocol suite, SONET (Synchronous Optical Networking), Ethernet, etc.).

The communication server 102 may request data from the listing data server 140 and the listing data server 140 may in response transmit listing data (i.e. MLS data) into the communication server 102. In some implementations, it may be desirable to have the listing server 140 automatically configured to communicate directly with the communication server 102.

The communication server 102 is configured as a hub to communication activities within the system 100. The communication server 102 is configured to receive client device requests, execute intermediary processing with external software and hardware components, and transmit response to client device 110. Moreover, the communication server 102 is configured to requests listing data from the listing data server 140 and receives a response from the listing data server 140 containing listing data. Also, the communication server 102 is configured to transmit payment transaction requests to a 3^{rd} party transaction server 150 and receive payment transaction response for each request sent in order to process electronic payment transactions. The communication server 102 is configured to communicate with the datastore 104 to archive, request and receive information.

The datastore 104 may store user information, user payment information, trial offer details, and MLS (listing) data. The datastore 104 may store trial offer conditions specified by either a real estate agent or a real estate owner. The datastore 104 may archive letters of intent submitted by potential buyers requesting trial occupancy from seller or owner of real estate. The datastore 104 may store transaction history when a transaction module 130 completes a transaction request. In some implementations, the datastore 104 may store information in an encrypted format via encrypted communication medium. In some implementations, the datastore 104 may store information for a predetermined period of time. For example, the database 104 may store transaction history up to 7 years. In addition, the datastore may store the entire interaction between a potential buyer and seller including their messaging information exchange, offers and acceptance of offers, and statistics related to the number of transactions associated with a specific real estate listing. The datastore 104 may host analytics information related to trial occupancy transactions, as well as other analytics related to other features permitted by the system.

The acceptance of the trial offer may be based on offer conditions or rules stored in the datastore 104. An offer conditions or rules may include one or more criteria (e.g., occupancy duration, deposit amount, age, submission of letter of intent, number of people staying, etc.). In some implementations, a potential buyer may qualify for multiple offers. The offer rule may specify whether the associated offer may be combined with other offers, supersedes other offers, or is a general offer. The offer rules may be provided by the seller or his agent via a client device 110.

The communication server 102 may include a listing search module 108. The listing search module 108 is configured to receive and respond to user requests submitted by client device 110 to search for listings maintained by the datastore 104. In another implementation, the listing search module 108 is configured to receive and respond to user request submitted by client device 110 to search for listings offering “try before you buy” trial occupancy among all listings available and searchable within the datastore 104. In addition, the listing search module 108 is configured to allow a seller or seller's agent to claim a listing to allow for further administration of the listing within an administration module (not shown) and allow for the seller or seller's agent to initiate and process trial occupancy agreements with buyers. In one embodiment, a potential buyer or buyer's agent may search for a property listed for sale within a specific geographic area having specific physical characteristics (e.g. number of bathrooms, number of rooms, square footage) and offering trial occupancy. In another embodiment, a seller or seller's agent may utilize the listing search module 108 to search of their specific listing listed on the MLS in order to claim the listing to administer the content of the listing. In another embodiment, a seller may utilize the listing search module 108 to add a listing for his/her home listed for sale by owner in order to advertise the listing to potential buyers and, in addition, offering a trial occupancy for their property listed for sale in order to allow potential buyers the ability to submit trial occupancy offers.

The communication server 102 may include a TBYB module 106. The TBYB module 106 is configured to receive and respond to user requests submitted by client device 110 to configure and process a trial offer and offer conditions for a listing submitted by either a seller or buyer of real estate. For example, a seller may claim a listing and input trial occupancy conditions for which the seller agrees to allow potential buyers who meet those conditions the opportunity to occupy the property listed for sale or rent for a trial duration in order to come to a determination if the property should be purchased or leased by the buyer. In another example, a seller may claim a listing and allow potential buyers to contact the seller or seller's agent directly in order to determine if a trial occupancy agreement can be reached. In yet another example, the buyer may use the TBYB module 106 to review the trial conditions of multiple property listings and select at least one property listed for sale for which to actually submit a trial occupancy offer to be considered by the seller or seller's agent. The trial occupancy offer may include a trial occupancy date, price to be paid per day of occupancy, deposit to be paid by seller, a letter of intent, a preliminary non-binding bid for the property, number of occupants to occupy the property during the trial occupancy period, and other conditions suggested or required by the seller or seller's agent.

The communication server 102 may include a transaction module 130. The transaction processing module 130 is configured to perform payment processing or payment remittance. The transaction processing module 130 may be configured to consummate the transaction. In some implementations, the transaction processing module 130 may be configured to communicate with a third party transaction server 150 to consummate the transaction. The third party transaction server 150 may be, in some implementations, a remittance and/or payment processing server such as an e-wallet, a bank, an automated clearing house, an online money transfer service, or a digital currency exchange.

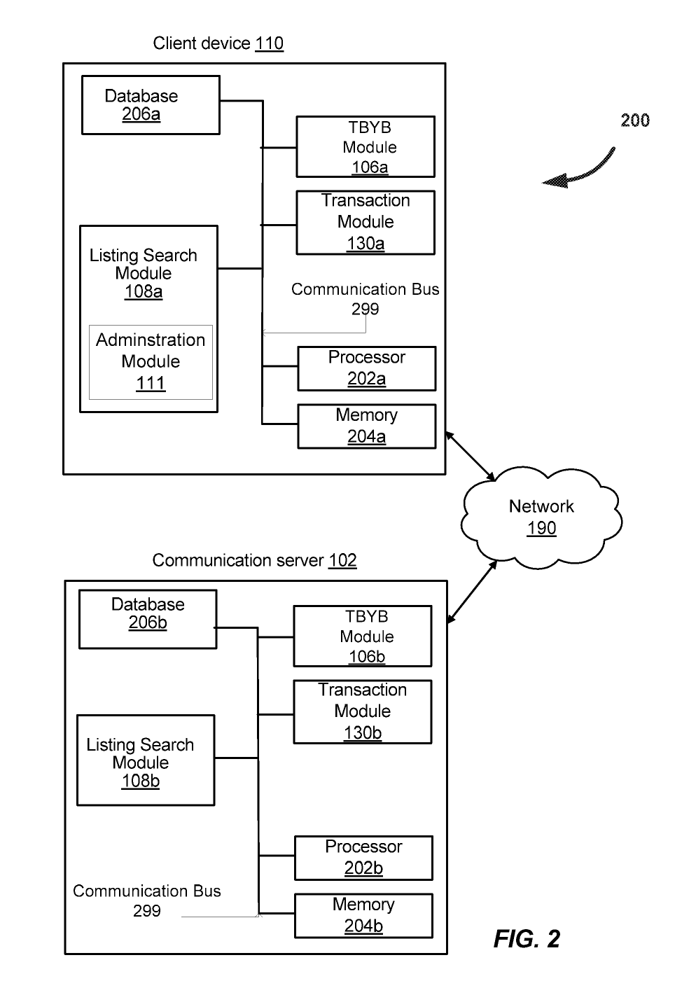

FIG. 2 is a functional block diagram of an exemplary wireless communication system in accordance with one embodiment. The electronic communication system may include a plurality of modules within the client device 110 that initiate requests or receive responses from respective components residing within the communication server 102.

The electronic communication system 200 may include a listing search module 108. In a client device, the listing search module 108a is configured to allow consumers to input real estate search criteria, such as, price, number of bedrooms, number of baths, and a zip code and receive the results of their search criteria. The client listing search module 108a may transmit the consumer input to the communications server 102. The server listing search module 108b receives the consumer input and is configured to access and search the datastore 104 to respond back to the client listing module 108a with search results. In addition, within the listing search module is the administration module 111 which allows home sellers or their agents to claim a listing or list real estate for sale. The administration module 111 is configured to allow a user to claim an MLS listing as his or her listing provided that specific credentials are verified by the user. Additionally, the administration module 11 is configured to allow a user to list real estate for sale directly within the system without requiring a seller to utilize an MLS to list their property. Furthermore, the real estate owner listing their home for sale without an MLS listing is permitted to claim their listing automatically upon initiation of real estate listing within the system. Moreover, the administration module 111 integrates with the TBYB module 106 to allow real estate owners listing their home for sale within an MLS to publish a trial occupancy offer with conditions. Additionally, the administration module 11 integrates with the TBYB module 106 to allow real estate owners or their representatives to claim an MLS listing if the real estate is listed on an MLS and publish a trial occupancy offer with conditions.

The electronic communication system 200 may include a TBYB module 106. In a client device, the TBYB module is configured to allow a user to publish an offer for trial occupancy, allows user to input and accept trial occupancy conditions, transmit user requests including dates of trial occupancy and letters of intent. In the communication server, the TBYB module is configured to receive and respond to trial occupancy requests by both buyers and sellers, maintain trial occupancy conditions, processing requests for trial occupancy, including letters of intent by potential buyers.

The electronic communication system 200 may include a database 206. In a client device, the database 206 is configured to store data generated by the modules within the client device 110. For example, the client database 206a may store client request, such as, search criteria input by the user or account information specific to the user. The server database 206a may store request and response information being processed by the plurality of modules within the communication server 102, such as, 30 days worth of search criteria for each user, payment information, or offer conditions.

The electronic communication system 200 may include a transaction module 260. In a client device, the transaction module 130a is configured to receive payment information and transmit the received information for processing or payment remittance. The payment information received by the transaction module 130 may include information required to process an electronic payment through a payment processing system, such as username, account number, payment address, expiration date, personal identification number, and the like. In a communication server 102, the transaction module 130b is configured to receive payment information from the client transaction module 130a and transmit the received information for processing or payment remittance by means of 3^{rd} party transaction server 150, as shown in FIG. 1. The 3^{rd} party transaction server 150 processes the transaction and transmits either an acceptance or rejection of payment requested initiated by the communication server 102. In server transaction module 130b is also configured to transmit the acceptance or rejection response of payment request initiated by the client transaction module 130a.

When the electronic communication system 200 is implemented as either a client device of a communication server, the memory 292 may include both read-only memory (ROM) and random access memory (RAM). The memory 204 may provide instructions and data to a processor 202. A portion of the memory 204 may also include non-volatile random access memory (NVRAM).

The processor 202 is configured to control operations of the electronic communication system 200. The processor 202 may also be referred to as a central processing unit (CPU). The processor 202 may perform logical and arithmetic operations based on program instructions stored within the memory 202. The instructions in the memory 204 may be executable to implement aspects of the methods described herein. The elements included in the electronic communication system 200 may be coupled by a bus 299. The bus 299 may be a data bus, communication bus, or other bus mechanism to enable the various components of the electronic communication system 200 to exchange information.

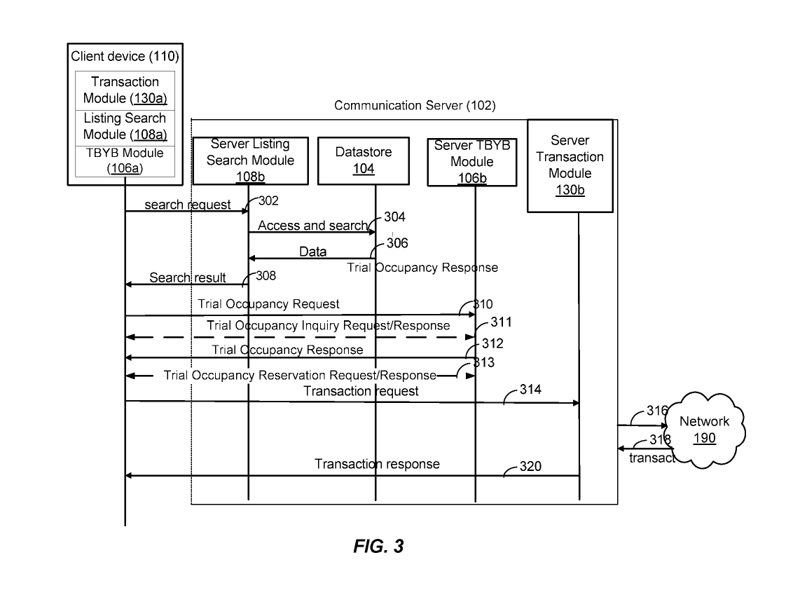

FIG. 3 is an exemplary message diagram for reserving a trial occupancy in accordance with one embodiment. The message flow of FIG. 3 shows messages exchanged between several entities which can be included in a communication system. For ease of explanation, the number of entities shown has been limited. However, it will be understood that additional entities can be added or multiple entities combined consistent with the description herein.

Messaging 302 may be performed by allowing a user of a client device to submit a search request. In one embodiment, a user of a client device executing application code and utilizing the client listing search module 108a to search or filter for particular real estate available for sale or rental. The listing search module 108a allows a user to input, by means of a user interface, search or filter criteria so that relevant search results are presented as a result. The client search module 108a does not have access to the real estate data to be presented to the user and as a result must transmit a request to the communication server 102 in order to handle the user's request to search. The client device listing search module 108a transmit a search request 302 to the communication server 102 where it's handled by the server listing search module 108b which accepts the request and handles further processing of the request.

Messaging 304 may be performed by transmitting a data request from the communication server 102 listing search module 108b to the datastore 104. In one embodiment, a search request 302 received by the server listing module 108b requires access and search of active listing data which is hosted within the datastore 104. The datastore 104 hosts large amounts of data, such as Multiple Listing Service (MLS) data, rental data, for sale by owner data, commercial real estate data, and other data related to real estate listings. In addition, the data store 104 may also store transaction data related financial transactions, trial offer conditions and offers. The datastore 104 is highly efficient and indexed in such a manner to allow for quick response to requests by the communication server 102.

Messaging 306 may be performed by transmitting data from the datastore 104 to the server listing search module 108b. In one embodiment, in response to the data request from the communication server 102, the datastore 104 will execute a query on its data and generate a result set based on the filter criteria within the request transmitted by the communication server 102 and transmit the result set to the communication server 102 server listing search module 108b. The result set or data transmitted in the response to the listing search module 108b is specifically tailored based upon the access and search request 304 received by the datastore 104.

Message 308 may be performed by transmitting search results from the server listing search module 108b to the client device listing search module 108a. In one embodiment, the communication server 102 server listing search module 108b receives data 306 from the datastore 104, arrange it in a manner to be responsive to the initial search request 302 and transmit search result 308 to the client device listing search module 108a where a user can view the real estate results based on the filter criteria he submitted in the search request 302.

Message 310 may be performed by transmitting trial offer request from the client device listing search module 108a to the server TBYB module 106a. In one embodiment, the potential buyer has identified a listing of real estate that is of interest and would like to transmit to the seller/owner a trial occupancy offer. The potential buyer may communicate with the Seller by means of telephone, email, or messaging communication prior to transmitting a trial occupancy offer. The offer both meets the seller's pre-defined trial offer conditions and is approved, or else the trial occupancy offer requires further review by the seller before a trial offer is confirmed. In one embodiment, the potential buyer using the client device 110 provides agrees to specific criteria that the seller has specifically outlined for trial occupancy to take place. In another embodiment, a potential buyer using the client device 110 provides any information he elects to provide to the seller in order to convey his interest in a trial occupancy and eventual purchase or rental of the real estate listed for sale or rental. In another example, a letter of intent may be required by the seller, to be initiated by the potential buyer, before a trial occupancy offer is accepted.

Message 311 may be performed by transmitting a trial occupancy response including an inquiry from the server TBYB module 106b to client TBYB module 106a and waiting for a response from the client device 110. In another embodiment, a seller/owner who has not pre-configured a set of conditions that would trigger a response, would have to manually review the trial occupancy response 310 received by the server TBYB module 106b. The server TBYB module 106b transmits a inquiry request to the client TBYB module 106a and awaits decision by the owner or agent to select either an approval or decline decision to be transmitted in the trial occupancy inquiry response 311 directed by to the communication server 102. After the server TBYB module 106b receives the trial occupancy inquiry response, it can determine the trial occupancy response 312 to be sent to the client device 110.

Message 312 may be performed by transmitting a trial occupancy response from the server TBYB module 106b to the client TBYB module 106a. In one embodiment, the seller/owner has configured a pre-defined set of conditions that if met by the potential buyer would trigger an automatic approval (or decline) trial occupancy response. In an alternative embodiment, the seller/owner requests to review of each potential buyer trial occupancy requests and after review, then transmits either an approval or decline trial occupancy response. The trial offer response message may contain information, such as, trial occupancy date range, deposit amount, letter of intent, approval to occupancy conditions, occupancy rate for the duration, tax information, number of people occupying the property during the trial occupancy, etc. A seller/owner who opts for the manual review process may also contact the potential buyer by means of email, phone, or instant messaging communication which may be built into the system.

Message 313 may be performed by transmitting a trail occupancy reservation request and response between the client device 110 client TBYB module 106a to the communication server 102 server TBYB module 106b. In one embodiment, after accepting the real estate owner's or agent's (i.e. Seller's) terms and conditions including a potential built in non-binding letter of intent (LOI) within the terms and conditions, a potential buyer will reserve the listing and thereafter, in Message 314 and Message 320, pay upfront the rental fees. The potential buyer (or guest) will create a user profile and upload their information including any agent they are being represented by.

Message 314 may be performed by transmitting a transaction request from the client device 110 to the server transaction module 130b. In one embodiment, a potential buyer who had previously transmitted a trial occupancy request 310 and received a favorable trial occupancy response 312 would confirm his commitment to the agreement by providing payment to the seller prior to, during or after trial occupancy period. In another embodiment, a potential buy that completed trial occupancy reservation request/response may be required to provide payment details to finalize the trial occupancy agreement between him and the Seller. The client device 110 is configured to allow a user to set a payment method and transmit the payment request to the server transaction module 130b. The transaction request message 314 may include payment method, amount to be paid, address information, authentication information, and other information required by the 3^{rd} party transaction server 150 (not shown) in order to process the transaction (payment) request 312.

Message 316 may be performed by the server transaction module 130b transmitting a request to the network 190 aimed for the 3^{rd} party transaction server 150 (not shown) in order to validate payment information.

Message 318 may be performed by the 3^{rd} party transaction server 150 (not shown) transmitting a response by means of the network 190 aimed for the server transaction module 130b in order to provide confirmation of payment information.

Message 318 may be performed by the server transaction module 310 transmitting a transaction response to the client device 110 to either confirm payment approval or confirm payment declined and request for new payment method. In one embodiment, payment may be required in order for trial occupancy offer to be finalized. In another embodiment, payment may not be required in order for trial occupancy offer to be finalized, but rather only the meeting of the minds where a potential buyer and seller/owner have satisfied a set of conditions thereby agreeing to trial occupancy of real estate.

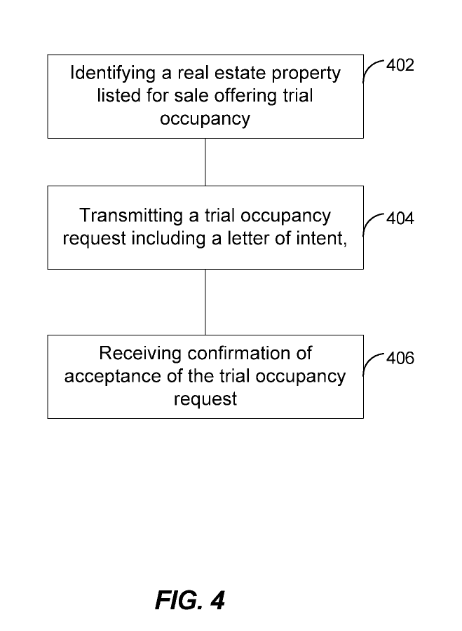

FIG. 4 is a flowchart for an exemplary method confirming trial occupancy in accordance with one embodiment. The method shown in FIG. 3 may be implemented in the listing search module 108 and TBYB module 106 in communication with the datastore 104 as shown in FIGS. 1 and 3.

At block 402, a potential buyer identifies a real estate property listed for sale offering trial occupancy. In one embodiment, a potential buyer utilizing the client listing search module 108 searching/filtering for those listings allowing for trial occupancy. The potential buyer within the listing search module 108 may receive search results that contain one or more listing permitting trial occupancy for real estate listed for sale or rental. The potential buyer may identify or select a specific real estate listed for sale or rental that permit trial occupancy, then the process may continue to block 404.

At block 404, a potential buyer who has identified a real estate property listed for sale offering a trial occupancy transmits a trial occupancy request including a letter of intent. In one embodiment, a potential buyer utilizing the client TBYB module 106 has read and understood the conditions that the seller has outlined for a trial occupancy to take effect and has transmitted a request which meets these conditions. In another embodiment, a potential buyer utilizing the client TBYB module 196 transmits a trial occupancy request for a listing without any trial occupancy conditions identified by the seller/owner. The letter of intent, provided by the user, may include the address of the property, name of potential buyer, name of potential seller, purchase or rental price, terms of purchase, deposit amount, number of days for which the letter of intent is enforceable from the date of execution, escrow details, or other negotiable terms. The potential buyer may request for trial occupancy separate from the letter of intent or may submit together in one transaction, and then the process may continue to block 406.

At block 406, a potential buyer who has identified a real estate property listed for sale offering trial occupancy and transmitted a trial occupancy request including a letter of intent receives a confirmation of acceptance of the trial occupancy. In one embodiment, a potential buyer utilizing the client TBYB module 106 automatically receives a confirmation of trial occupancy. In another embodiment, a potential buyer utilizing the client TBYB module 196 receives confirmation by email, phone, instant message, or mail delivery for acceptance of trial occupancy request. The process ends after confirmation of trial occupancy is dispatched. However, in some instances, the potential buyer may provide the seller/owner with a deposit or payment for the trial occupancy for the trial occupancy agreement to be considered binding, and then the process ends.

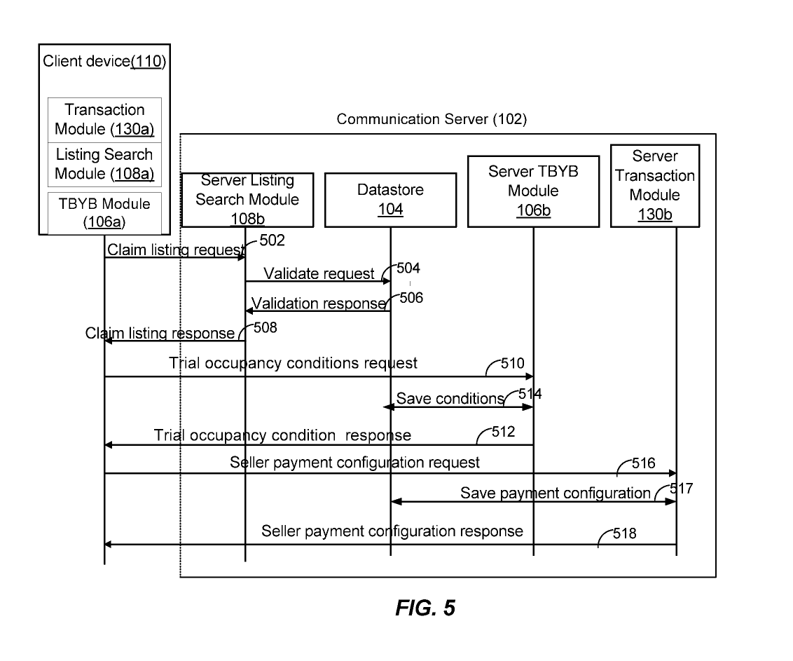

FIG. 5 is an exemplary message diagram claiming a listing and configuring a trial occupancy in accordance with one embodiment. The message flow of FIG. 5 shows messages exchanged between several entities which can be included in a communication system. For ease of explanation, the number of entities shown has been limited. However, it will be understood that additional entities can be added or multiple entities combined consistent with the description herein.

Messaging 502 may be performed by allowing a user of a client device 100 utilizing the listing search module 108a to transmit a claim listing request to the communication server 102 server listing search module 108. In one embodiment, a real estate agent/seller with an active listing published by means of a listing service (i.e. MLS) may search for the listing using the listing search module 108a and transmit a request to claim the listing to the communication server 102. In another embodiment, an owner of real estate listed “for sale by owner” may use the listing search module 108a to add a listing for his/her real estate and automatically claim his/her listing without any further validation. In another embodiment, a real estate agent is notified by email 24-48 hours after his listing is uploaded to the datastore that he is eligible to claim the listing. In another embodiment, a real estate owner of a listing listed “for rent by owner’ may use the listing search module 108a to add a listing for his/her real estate and automatically claim his/her listing without any further verification.

Messaging 504 may be performed by transmitting a validation request from the server listing search module 108b to the datastore 104. In one embodiment, the server listing search module 108b transmits information to the datastore, such as, real estate agent license number, real estate owner name, or other identifying information which can be matched to the listing service (i.e. MLS). The datastore 104 receives the information and executes a query to determine if the information provided is a match.

Messaging 506 may be performed by transmitting a validation response from the datastore 104 to the server listing search module 108b. In one embodiment, after the datastore 104 has completed its query and it can transmit a validation response 506 in response to the validation request 504. The validation response 506 may include an affirmation or rejection result depending on the information provided by validation request 504. In another embodiment, the validation response 506 may contain other information that is processed by the server listing search module 108b for final validation. In one embodiment, upon receiving the validation response from the datastore 104 the communication server 102 automatically transmits a claim listing response 508 to the client device 110. In another embodiment, upon receiving the validation response from the datastore 104 the communication server 103 executes program logic then transmits a claim listing response 508 to the client device 110.

Messaging 508 may be performed by transmitting a claim listing response from the server listing search module 108b to the client listing search module 108a. In one embodiment, the claim listing response 508 may includes information that would allow the user who initiated the claim listing request 502 to claim the listing. In another embodiment, the claim listing response 508 may includes information that would disallow the user who initiated the claim listing request 502 to claim the listing.

Messaging 510 may be performed by transmitting a trial offer conditions request from the client TBYB module 106a to the server TBYB 106b. In one embodiment, after claiming the listing, the seller or his agent will get access to an admin dashboard (not shown) within the client TBYB module 106a containing availability, pricing, calendar, listing profile, features and amenities, policies, cleaning deposits, etc. In one embodiment, after the seller or his agent claims a listing, then the seller or his agent may be able to provide a listing of conditions that a potential buyer may or must meet in order for trial occupancy to be enabled for the specific listing claimed by the user. In another embodiment, after a user is able to claim a listing, the user may opt to not list any conditions and allow potential buyers to initiate trial occupancy request without any moderation. Trial offer conditions request 510 may contain information such as, deposit amount, cleaning fee, minimum occupancy date range, number of occupants, pet conditions, noise conditions, waivers, daily rate, weekly rate, monthly rate, emergency contact, etc. It can be understood that many other relevant conditions can be added or omitted from the trial occupancy condition request without straying from its intended purpose.

Messaging 512 may be performed by transmitting a trial occupancy response from the server TBYB module 106b to client TBYB module 106a. In one embodiment, the server TBYB module 106b transmits a confirmation that all conditions specified in the trial occupancy response 510 have been accepted by the system and will be saved. The server TBYB module 106b may execute program logic to determine if the conditions provided in the trial occupancy conditions request 510 meet the system excepted criteria and, if so, transmit a response to confirm conditions meet expectations.

Messaging 514 may be performed by Server TBYB module 106b requesting that conditions be stored in the datastore 104 and receiving confirmation response message (not shown) that conditions have been stored successfully. In one embodiment, the server TBYB module 106b transmits a request to the datastore 104 to store trial occupancy conditions before trial occupancy condition response 512 is transmitted. In another embodiment, the server TBYB module 106b transmits a request to the datastore 104 to store trial occupancy conditions after or concurrent with trial occupancy condition response 512 being transmitted.

Messaging 516 may be performed by transmitting a seller payment configuration request 516 from the client device 110 within the client transaction module 130a to the server transaction module 130b. In one embodiment, the seller or agent that claimed a listing and, optionally, provided conditions for trial occupancy may be permitted to configure payment details, such as, accepted methods of payment, bank account information where payments should be deposited, or other information to allow the seller/agent to be compensated when trial occupancy is arranged.

Messaging 517 may be performed by transmitting payment configuration request information to the datastore 104. In one embodiment, the server transaction module 130b may determine if seller payment configuration request 512 contains valid information that meets strict criteria set by 3^{rd} party transaction server 150 (FIG. 1) before initiating a save payment configuration request 517 to the datastore 104. In another embodiment, if the seller payment configuration request 512 contains invalid information that does not meet strict criteria set by 3^{rd} party transaction server 150 (FIG. 1) then the server TBYB module 106b may save some data or not save any data to the datastore 104 as a result of failure to meet strict payment criteria. In another embodiment, the server transaction module 130b my transmit a test request to a third party transaction server 150 to verify payment configuration is valid before initiating a save payment configuration request 517 to the datastore 104. In another embodiment, the save payment configuration request 517 may be both a request and response message rather than a unidirectional request message.

Messaging 518 may be performed by transmitting a seller payment configuration response from the server transaction module 130b to the client transaction module 130a. In one embodiment, after the server transaction module 130b has determined that the seller payment configuration request 516 meets payment configuration criteria and a save payment configuration request/response 517 has successfully completed, and then it will transmit a seller payment configuration response 518. The seller payment configuration response may include information such as, invalid bank account number, invalid 3^{rd} party payment processor username/password, successful payment configuration, or other valid/invalid conditions that may be a result of seller payment configuration request 516 validated against a 3^{rd} party transaction server 150.

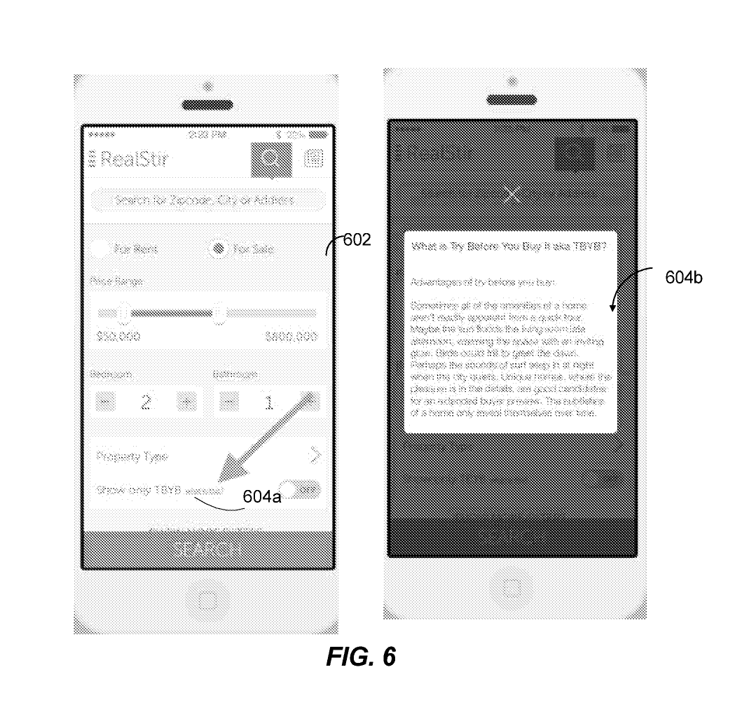

FIG. 6 is an exemplary illustration of the client listing search module 108a in one embodiment of the invention. The search screen 602 within the client listing search module 108a permits a user to input a search criteria (or filter) to conduct a real estate search. In one embodiment, a user may input a zip code, city or address, search for real estate for sale or for rent, search within a specific price range, configure the number of bedrooms, and number of bathrooms, select the type of property (i.e. single family attached home, duplex, condo, etc.) and enable or disable “try before you buy” (TBYB) search criteria. In one embodiment, a home listed for sale may allow for temporary or trial occupancy by potential buyers. In another embodiment, a home listed for rent may allow for temporary or trial occupancy by potential renters. By clicking on the link (what is this?) 604a the user is presented with a detailed TBYB explanation 604b which explains what is try before you buy in detail. The user can execute his search criteria and will receive resulting data on real estate for rent or purchase based on his pre-defined search criteria. If the user enables TBYB within the listing search module 108a then only those real estate listings which allow for trial occupancy will be returned in the result set, or optionally, they will be set to display at the top of the search results based on relevance.

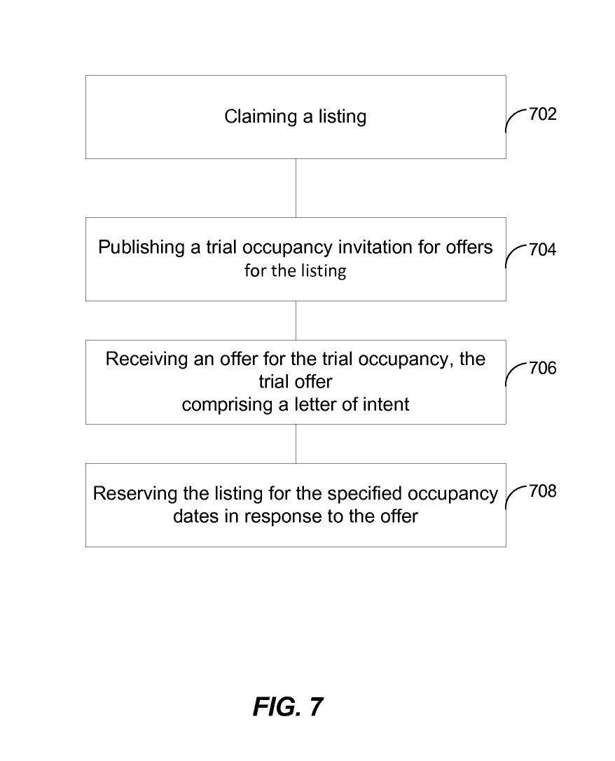

FIG. 7 is a flowchart for an exemplary method confirming trial occupancy in accordance with one embodiment. The method shown in FIG. 7 may be implemented in the listing search module 108, TBYB module 106, and the transaction module 130 in communication with the datastore 104 as shown in FIGS. 1, 3 and 5.

At block 702, an agent or owner claims a listing searchable within the system. In one embodiment, the agent provides his license number and is automatically associated or linked to the specific listing as the listing agent. In another embodiment, the owner of real estate listed “for sale by owner” may be automatically claimed associated to the owner who listed it for sale. In yet another embodiment, the owner of real estate or agent may need to provide further information to validate his ownership of the property, such as annual taxes paid, copy of driver's license, copy of trust for which the property is legal held in title, etc. After strict validation is completed by the system, the user will be associated or link to a real estate listing, sometimes referred to as claiming a listing.

At block 704, after an agent or owner has claimed a listing, the agent or owner may publish a trial occupancy offer for the listing. In one embodiment, the agent or owner may configure a custom “try before you buy” trial occupancy for potential renters or buyers of real estate by establishing the conditions before a trial occupancy can take place. The conditions that an agent or owner of real estate may provision for include deposit amount, available dates, cleaning fee, daily rate, minimum stay, number of people per stay, pets allowed/not allowed, credit card pre-authorization, expiration date, letter of intent, etc. and numerous other conditions that the agent or owner can stipulate in a custom interface within the client TBYB module 106a. After the agent or owner of real estate has outlined all conditions for trial occupancy, the agent or owner can publish this information and transmit it to the communication server for further processing as explained in FIG. 5.

At block 706, after an agent or owner has claimed a listing and published availability of trial occupancy for the listing then the agent can expect to receive offers or requests from potential buyers with interest in carrying out trial occupancy. In one embodiment, the agent with an associated listing and published trial occupancy receives an offer for trial occupancy, the trial offer comprising a letter of intent and meeting all pre-conditions set out by the client TBYB module 106a. In another embodiment, the agent with an associated listing and published trial occupancy receives an offer for trial occupancy, the trial offer comprising a letter of intent and meeting some pre-conditions set out by the client TBYB module 106a.

At block 708, the agent or owner of real estate reserves the real estate for the occupancy dates specified in the offer in response to the offer. In one embodiment, after an agent or owner has received an satisfactory offer for trial occupancy the agent or owner reserves (or confirms approval) of the real estate for the occupancy dates listed in the trial occupancy offer in response to acceptance of the offer.

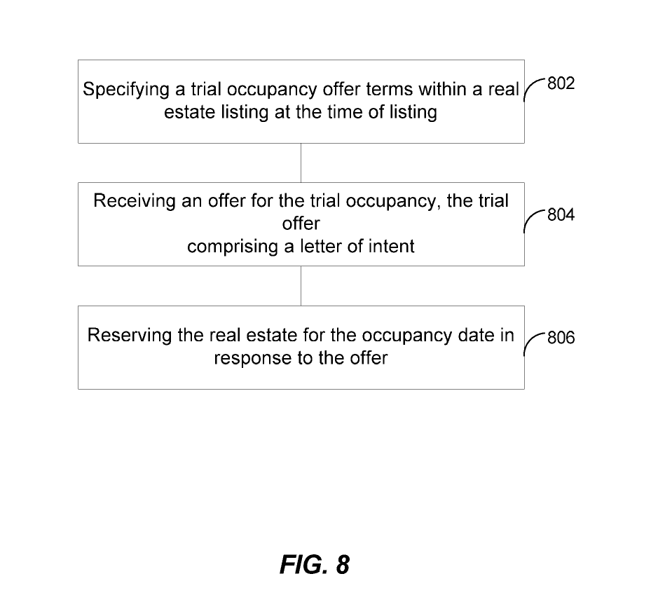

FIG. 8 is a flowchart for an exemplary method confirming trial occupancy in accordance with one embodiment. The method shown in FIG. 8 may be implemented in the listing search module 108, TBYB module 106, and the transaction module 130 in communication with the datastore 104 as shown in FIGS. 1, 3 and 5.

At block 802, an agent or owner specifies a trial occupancy offer terms within a real estate listing at the time of listing. In one embodiment, a real estate agent during the time of preparing the listing for the listing service (i.e. MLS) will actually include trial occupancy information (such as conditions for which trial occupancy would be permitted) within the listing data that would allow the listing service (i.e. MLS) to propagate the trial occupancy offer to any web-site or application that integrates with listing service (i.e. MLS) data to allow the trial occupancy offer terms to be available to potential buyers. In another embodiment, a owner of a “for sale by owner” or “for rent by owner” property may at the time of listing his real estate onto the system will actually provide sufficient information (such as conditions for which trial occupancy would be permitted) within the listing data to allow the system to display the trial occupancy offer terms to potential buyers using the system.

At block 804, an agent or owner of real estate receives an offer for the trial occupancy, the trial offer comprising a letter of intent. In one embodiment, a real estate agent receives an offer for trial occupancy that meets the pre-specified trial occupancy conditions and includes a letter of intent specifying the potential buyer's interest in the property. In another embodiment, a real estate owner receives an offer for trial occupancy for a home listed for sale by owner, the trial offer comprising a letter of intent. Similarly, a real estate owner or his agent receives an offer for trial occupancy for a listing listed for rent, the trial offer comprising a letter of intent. In yet another embodiment, a real estate agent or homeowner receives an offer for trial occupancy from a potential buyer, without the real estate agent or owner listing the property as eligible for trial occupancy, and the owner or agent transmits a response to agree to the offer terms.

At block 806, an agent or real estate owner reserves the real estate for the occupancy dates in response to the offer. In one embodiment, a real estate agent reserves the real estate listed for sale or rental for the occupancy dates specified in the trial occupancy offer in response to the offer meeting a pre-defined set of conditions and including a satisfactory letter of intent. In another embodiment, an owner of real estate whom receives a trial occupancy offer from a potential buyer including a satisfactory letter of intent from the potential buyer ascends to the offer and reserves the residence for the dates specified in the trial occupancy offer. Moreover, the real estate agent or real estate owner may communicate with the potential buyer regarding the confirmation of their ascent to the offer and reserving the real estate for the potential buyer for the dates specified in the offer. In yet another embodiment, the potential buyer or renter (a.k.a. Buyer) may reserve the listing after the Seller has received and agreed to the trial occupancy offer.

After the trial occupancy is completed, the listing agent (and buyer's agent, if there is one) will get an email informing them that a specific guest has completed a trial occupancy of the property. This protects agents from Seller and Buyer (guest) going around agents. Also it provides a conduit for agent to follow up with guest to get feedback etc. Follow up to buyer/guest can only be done through messaging/chat system. A separate email, text or chat message will be sent to buyer/guest asking them to provide feedback on property (elective) and the feedback will be sent and shared with seller and listing agent and buyer agent if applicable. Buyer/guest may also leave a public review of the listing and amenities. Seller can respond to these reviews as necessary.

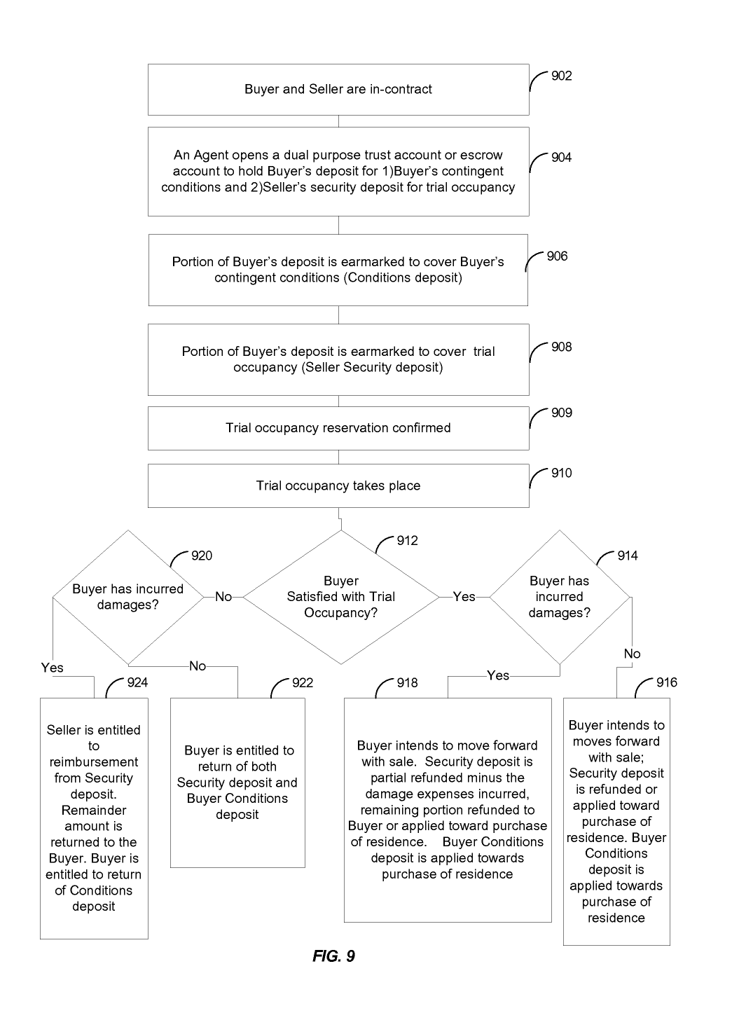

FIG. 9 is a flowchart for an exemplary method of reserving a trial occupancy and handling both a security deposit and conditions deposit, in accordance with one embodiment. The method shown in FIG. 9 may be implemented in the listing search module 108, TBYB module 106, and the transaction module 130 in communication with the datastore 104 as shown in FIGS. 1, 3 and 5.

At block 902, a buyer and a seller are assumed to be in contract. In one embodiment, a seller has advertising his residence for purchase by another, and a willing buyer has provided an offer for the residence along with contingent conditions and a deposit, the offer is received and acceptance by the seller. When buyer and seller are in contract, it's presumed that they have reached an agreement as to the purchase price, deposit amount, contingent conditions, and other possible real estate sale requirements. In one embodiment, the buyer includes a contingent condition that he must be allowed to reside in the residence for a trial occupancy and that only a favorable stay in his subjective view would operate as a satisfaction of the contingent condition.

At block 904, an agent opens a dual purpose trust account or escrow account to hold buyer's deposit for buyer's contingent conditions and seller's security deposit for trial occupancy. In one embodiment, a real estate agent initiates a dual purpose trust account to hold deposit amount provided by the buyer for the benefit of the seller, in order to take the residence off the market from other potential buyers. In another embodiment, the real estate agent may open two separate trust accounts to maintain the buyer's contingent conditions deposit separate from the seller's security deposit for trial occupancy (which may be opened after a trial occupancy reservation is confirmed or accepted by the seller).

At block 906, a real estate agent identifies the portion of buyer's deposit earmarked to cover buyer's contingent conditions (conditional deposit). In an embodiment, the buyer may spell out contingent conditions within a real estate sales contract that he is unwilling the residence if the following conditions occur, the appraisal is returned under the purchase price, the inspection uncovers costly repairs or damage to property, and unfavorable subjective view of the home after a trial occupancy of the residence takes place during the right of inspection period allowed in real estate contracts. For these contingent conditions, if any of them an return unfavorable in the prospective of the buyer, then has the right to reimbursement of the contingent deposit.

At block 908, a real estate agent identifies the portion of buyer's deposit earmarked to cover trial occupancy deposit (seller's security deposit). In one embodiment, the buyer may spell out a certain amount of money, $1,500 for example, that he is willing to set aside in a trust account or escrow account for the benefit of the owner, which is activated only if the trial occupancy of the residence comes to pass, and is used to cover costs associated to personal/real property, costs related to over-staying the trial tenancy, costs related to ejection of buyer from property (if un-willing to leave), lost opportunity costs associated with stay over tenant, and any legal fee's which arise as a result.

At block 909, a trial occupancy reservation is confirmed. In one embodiment, the seller will activate the listing for the residence to be enabled for trial occupancy within the system described in FIG. 1, the buyer will submit an offer for trial occupancy and agree to the terms and fee's associated thereto. Thereafter, the seller will accept the offer for trial occupancy and confirm the arrival date and occupancy date range.

At block 910, the trial occupancy takes place. In one embodiment, the buyer may be permitted to stay overnight in the listed residence and observe the residence more privately and intimately. Some may refer to this step as an extended showing of the home. A trial occupancy may allow the buyer to see for himself/herself the true nature of this residence, if purchased.

At block 912, the buyer determines if the trial occupancy was satisfactory to his/her expectations. In one embodiment, the buyer may determine in his/her subjective view that the trial occupancy stay was unsatisfactory. In another embodiment, the buyer may determine in his/her subjective view that the trial occupancy stay was satisfactory.

At block 914, given that the buyer is satisfied with the trial occupancy, a decision is made as to whether the trial occupancy by the buyer has incurred damages or not. In one embodiment, damages which may arise during a trial occupancy include damage to seller's personal property, damage to seller's real property, fee's associated with staying over past the trial occupancy departure date, fee's associated with Ejectment from the property, as well as other fee's which may arise from short term rental of a residential real estate.

At block 916, the buyer is satisfied with the trial occupancy and has incurred no damages as a result of his/her trial occupancy. In one embodiment, the buyer intends to move forward with the sale, the security deposit may be refunded or applied towards the purchase of the residence. The buyer conditions deposit may be applied towards the purchase of the residence.

At block 918, the buyer is satisfied with the trial occupancy, but has incurred damages as a result of his/her trial occupancy. In one embodiment, the buyer intends to move forward with the purchase of the residence; the security deposit is partially refunded, less the damage expenses incurred, remaining portion of the security deposit are refunded to the buyer or applied towards the purchase of residence; the buyer's conditions deposit may be applied towards the purchase of the residence.

At block 920, given that the buyer is unsatisfied with the trial occupancy, a decision is made as to whether the trial occupancy by the buyer has incurred damages or not. In one embodiment, damages which may arise during a trial occupancy include damage to seller's personal property, damage to seller's real property, fee's associated with staying over past the trial occupancy departure date, fee's associated with Ejectment from the property, as well as other fee's which may arise from short term rental of a residential real estate.

At block 922, the buyer is unsatisfied with the trial occupancy, and has incurred no damages as a result of his/her trial occupancy. In one embodiment, the buyer may be entitled to return of both a security deposit and a buyer's conditions deposit.

At block 924, that the buyer is unsatisfied with the trial occupancy, but has incurred damages as a result of his/her trial occupancy. In one embodiment, the seller may be entitled to reimbursement from security deposit; remainder of the security deposit returned to the buyer; the buyer entitled to return of conditions deposit.

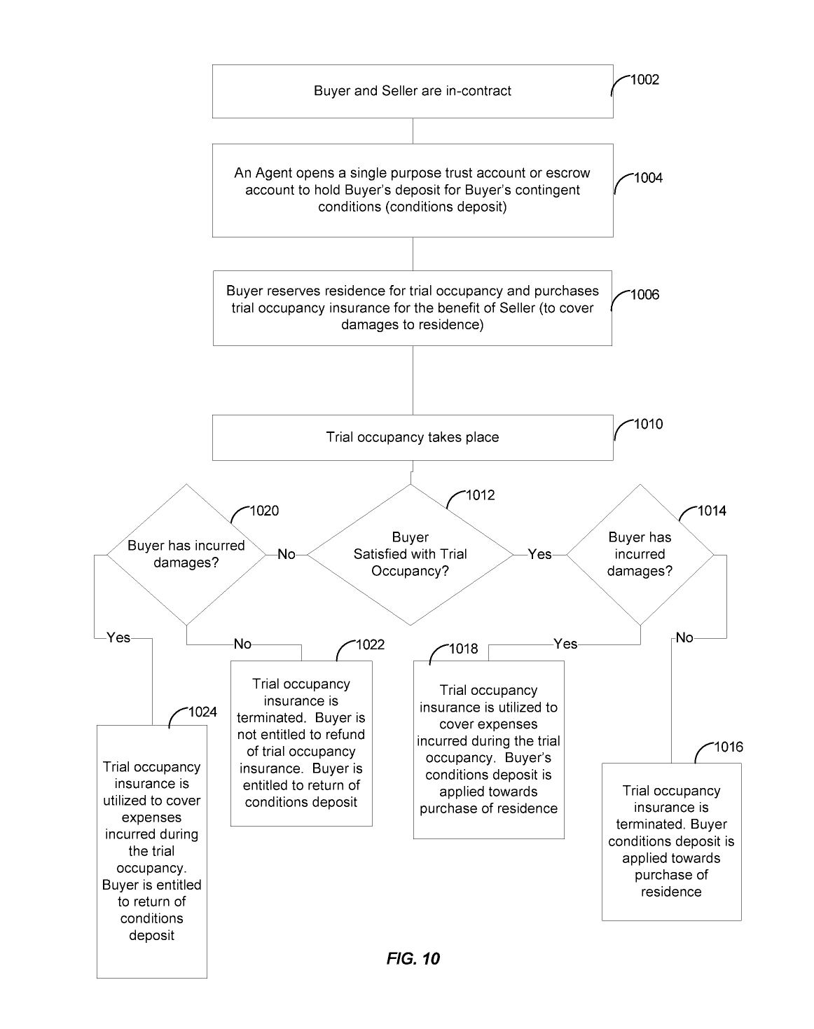

FIG. 10 is a flowchart for an exemplary method of reserving a trial occupancy and handling both a trial occupancy insurance policy and contingent conditions deposit in accordance with one embodiment. The method shown in FIG. 10 may be implemented in the listing search module 108, TBYB module 106, and the transaction module 130 in communication with the datastore 104 as shown in FIGS. 1, 3 and 5.

At block 1002, a buyer and a seller are assumed to be in contract. In one embodiment, a seller has advertising his residence for purchase by another, and a willing buyer has provided an offer for the residence along with contingent conditions and a deposit, the offer is received and acceptance by the seller. When buyer and seller are in contract, it's presumed that they have reached an agreement as to the purchase price, deposit amount, contingent conditions, and other possible real estate sale requirements. In one embodiment, the buyer includes a contingent condition that he must be allowed to reside in the residence for a trial occupancy and that only a favorable stay in his subjective view would operate as a satisfaction of the contingent condition.

At block 1004, an agent opens a single purpose trust account or escrow account to hold buyer's deposit for buyer's contingent conditions (conditions deposit). In one embodiment, a real estate agent may open a trust account and hold the buyer's earnest money deposit in trust for the benefit of the sellers, if the contingent conditions are extinguished. The agent may or may not use this buyer's deposit as a security interest for the seller in case the buyer incurs damages during the trial occupancy. In one embodiment, the buyer may spell out a certain amount of money, $1,500 for example, that he is willing to set aside in a trust account or escrow account for the benefit of the owner, which is activated only if the trial occupancy of the residence comes to pass, and is used to cover costs associated to personal/real property, costs related to over-staying the trial tenancy, costs related to ejection of buyer from property (if un-willing to leave), lost opportunity costs associated with stay over tenant, and any legal fee's which arise as a result.

At block 1006, the buyer reserves the residence for trial occupancy and purchases trial occupancy insurance for the benefit of seller (to cover damages to residence). In one embodiment, the seller will activate the listing for the residence to be enabled for trial occupancy within the system described in FIG. 1, the buyer will submit an offer for trial occupancy, including purchase of trial occupancy insurance, and agree to the terms and fee's associated thereto. Thereafter, the seller will accept the offer for trial occupancy and confirm the arrival date and occupancy date range.

At block 1010, the trial occupancy takes place. In one embodiment, the buyer may be permitted to stay overnight in the listed residence and observe the residence more privately and intimately. Some may refer to this step as an extended showing of the home. A trial occupancy may allow the buyer to see for himself/herself the true nature of this residence, if purchased.

At block 1012, the buyer determines if the trial occupancy was satisfactory to his/her expectations. In one embodiment, the buyer may determine in his/her subjective view that the trial occupancy stay was unsatisfactory. In another embodiment, the buyer may determine in his/her subjective view that the trial occupancy stay was satisfactory.

At block 1014, if the buyer is satisfied with the trial occupancy, a decision is made as to whether the trial occupancy by the buyer has incurred damages or not. In one embodiment, damages which may arise during a trial occupancy include damage to seller's personal property, damage to seller's real property, fee's associated with staying over past the trial occupancy departure date, fee's associated with Ejectment from the property, as well as other fee's which may arise from short term rental of a residential real estate.

At block 1016, the buyer is satisfied with the trial occupancy and has incurred no damages as a result of his/her trial occupancy. In one embodiment, the buyer intends to move forward with the sale, the trial occupancy insurance is terminated. The buyer conditions deposit may be applied towards the purchase of the residence.

At block 1018, the buyer is satisfied with the trial occupancy, but has incurred damages as a result of his/her trial occupancy. In one embodiment, the buyer intends to move forward with the purchase of the residence; the trial occupancy insurance is utilized to cover expenses uncured during the trial occupancy; the buyer's conditions deposit may be applied towards the purchase of the residence. In another embodiment, the buyer's conditions deposit may be paid to the seller in the event that the trial occupancy insurance does not cover the damage incurred as a result of the trial occupancy.

At block 1020, given that the buyer is unsatisfied with the trial occupancy, a decision is made as to whether the trial occupancy by the buyer has incurred damages or not. In one embodiment, damages which may arise during a trial occupancy include damage to seller's personal property, damage to seller's real property, fee's associated with staying over past the trial occupancy departure date, fee's associated with Ejectment from the property, as well as other fee's which may arise from short term rental of a residential real estate.

At block 1022, the buyer is unsatisfied with the trial occupancy, and has incurred no damages as a result of his/her trial occupancy. In one embodiment, the trial occupancy insurance is terminated; the buyer is not entitled to a refund of the trial occupancy insurance; however, the buyer may be entitled to return of the buyer's conditions deposit.

At block 1024, the buyer is unsatisfied with the trial occupancy, but has incurred damages as a result of his/her trial occupancy. In one embodiment, the trial occupancy insurance may be utilized to cover expenses incurred during the trial occupancy; the buyer may be entitled to return of conditions deposit, with limitations that the conditions deposit may be reduced if applied to cover damages incurred not covered by the trial occupancy insurance.

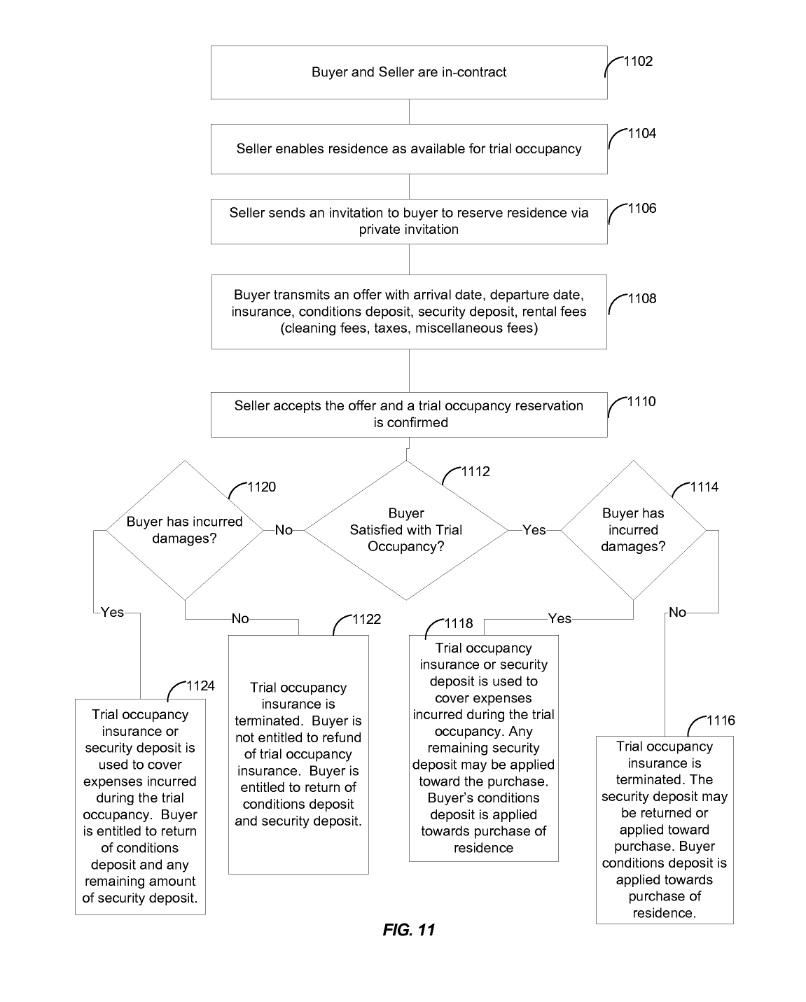

FIG. 11 is a flowchart for an exemplary method of reserving a trial occupancy and handling both a trial occupancy insurance policy and contingent conditions deposit in accordance with one embodiment. The method shown in FIG. 10 may be implemented in the listing search module 108, TBYB module 106, and the transaction module 130 in communication with the datastore 104 as shown in FIGS. 1, 3 and 5.

At block 1102, a buyer and a seller are assumed to be in contract. In one embodiment, a seller has advertising his residence for purchase by another, and a willing buyer has provided an offer for the residence along with contingent conditions and a deposit, the offer is received and acceptance by the seller. When buyer and seller are in contract, it's presumed that they have reached an agreement as to the purchase price, deposit amount, contingent conditions, and other possible real estate sale requirements. In one embodiment, the buyer includes a contingent condition that he must be allowed to reside in the residence for a trial occupancy and that only a favorable stay in his subjective view would operate as a satisfaction of the contingent condition.

At block 1104, the seller enables residence as available for trial occupancy. In one embodiment, the seller creates an account, claims his/her listing, then setup the listing to be reserved by a buyer by configuring availability dates, nightly rate, cleaning/rental fees, security deposit amount, etc. The seller may configure the trial occupancy to be privately or publically displayed to buyers.

At block 1106, the seller sends an invitation to buyer to reserve residence via private invitation. In one embodiment, the seller is logged into the platform, claimed his/her listing, has enabled the listing for trial occupancy, and sends a private link or request to a specific buyer for trial occupancy reservation.

At block 1108, the buyer transmits an offer with arrival date, departure date, insurance, security deposit, rental fees (cleaning fee's, taxes, and miscellaneous fee's). In one embodiment, the buyer navigates to the private link provided by the seller, selects a respective arrival date, duration of stay, agrees to trial occupancy restrictions/limitations, reviews accommodation description, agrees to purchase insurance (optional), agrees to a security deposit amount (optional), agrees to rental fees, agrees to cleaning fees, agrees to transaction fees, other optional/require criteria, then submit his offer through the platform to be transmitted to the seller.

At block 1110, the seller accepts the offer and the reservation confirmed. In one embodiment, the seller receives the trial occupancy trial offer which was transmitted to the seller through the platform; after review the seller may accept the trial occupancy offer; thereafter the reservation is confirmed to both the seller and the buyer.

At block 1012, the buyer determines if the trial occupancy was satisfactory to his/her expectations. In one embodiment, the buyer may determine in his/her subjective view that the trial occupancy stay was unsatisfactory. In another embodiment, the buyer may determine in his/her subjective view that the trial occupancy stay was satisfactory.

At block 1014, if the buyer is satisfied with the trial occupancy, a decision is made as to whether the trial occupancy by the buyer has incurred damages or not. In one embodiment, damages which may arise during a trial occupancy include damage to seller's personal property, damage to seller's real property, fee's associated with staying over past the trial occupancy departure date, fee's associated with Ejectment from the property, as well as other fee's which may arise from short term rental of a residential real estate.

At block 1116, the buyer is satisfied with the trial occupancy and has incurred no damages as a result of his/her trial occupancy. In one embodiment, the buyer intends to move forward with the sale, the trial occupancy insurance is terminated. The buyer conditions deposit may be applied towards the purchase of the residence.

At block 1118, the buyer is satisfied with the trial occupancy, but has incurred damages as a result of his/her trial occupancy. In one embodiment, the buyer intends to move forward with the purchase of the residence; the trial occupancy insurance or security deposit may utilized to cover expenses uncured during the trial occupancy; the buyer's conditions deposit may be applied towards the purchase of the residence. In another embodiment, the buyer's conditions deposit may be paid to the seller in the event that the trial occupancy insurance does not cover the damage incurred as a result of the trial occupancy.

At block 1120, given that the buyer is unsatisfied with the trial occupancy, a decision is made as to whether the trial occupancy by the buyer has incurred damages or not. In one embodiment, damages which may arise during a trial occupancy include damage to seller's personal property, damage to seller's real property, fee's associated with staying over past the trial occupancy departure date, fee's associated with Ejectment from the property, as well as other fee's which may arise from short term rental of a residential real estate.

At block 1122, the buyer is unsatisfied with the trial occupancy, and has incurred no damages as a result of his/her trial occupancy. In one embodiment, the trial occupancy insurance is terminated; the buyer is not entitled to a refund of the trial occupancy insurance; however, the buyer may be entitled to return of the buyer's conditions deposit.

At block 1124, the buyer is unsatisfied with the trial occupancy, but has incurred damages as a result of his/her trial occupancy. In one embodiment, the trial occupancy insurance or security deposit may be utilized to cover expenses incurred during the trial occupancy; the buyer may be entitled to return of conditions deposit, with limitations that the conditions deposit may be reduced if applied to cover damages incurred not covered by the trial occupancy insurance.

Various aspects of the novel systems, apparatuses, and methods are described more fully hereinafter with reference to the accompanying drawings. The teachings disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the novel systems, apparatuses, and methods disclosed herein, whether implemented independently of or combined with any other aspect of the invention. For example, an apparatus may be implemented or a method may be practiced using any number of the aspects set forth herein. In addition, the scope of the invention is intended to cover such an apparatus or method which is practiced using other structure, functionality, or structure and functionality in addition to or other than the various aspects of the invention set forth herein. It should be understood that any aspect disclosed herein may be embodied by one or more elements of a claim.

Although particular aspects are described herein, many variations and permutations of these aspects fall within the scope of the disclosure. Although some benefits and advantages of the preferred aspects are mentioned, the scope of the disclosure is not intended to be limited to particular benefits, uses, or objectives. Rather, aspects of the disclosure are intended to be broadly applicable to different data access technologies, system configurations, networks, and transmission protocols, some of which are illustrated by way of example in the figures and in the following description of the preferred aspects. The detailed description and drawings are merely illustrative of the disclosure rather than limiting, the scope of the disclosure being defined by the appended claims and equivalents thereof.

The various operations of methods described above may be performed by any suitable means capable of performing the operations, such as various hardware and/or software component(s), circuits, and/or module(s). Generally, any operations illustrated in the Figures may be performed by corresponding functional means capable of performing the operations.

The various illustrative logical blocks, modules and circuits described in connection with the present disclosure may be implemented or performed with a general purpose processor, a digital signal processor (DSP), an application specific integrated circuit (ASIC), a field programmable gate array signal (FPGA) or other programmable logic device (PLD), discrete gate or transistor logic, discrete hardware components or any combination thereof designed to perform the functions described herein. A general purpose processor may be a microprocessor, but in the alternative, the processor may be any commercially available processor, controller, microcontroller or state machine. A processor may also be implemented as a combination of computing devices, e.g., a combination of a DSP and a microprocessor, a plurality of microprocessors, one or more microprocessors in conjunction with a DSP core, or any other such configuration.

In one or more aspects, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blue-ray disc where disks usually reproduce data magnetically, while discs reproduce data optically with lasers. Thus, in some aspects computer readable medium may comprise non-transitory computer readable medium (e.g., tangible media). In addition, in some aspects computer readable medium may comprise transitory computer readable medium (e.g., a signal). Combinations of the above should also be included within the scope of computer-readable media.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

Software or instructions may also be transmitted over a transmission medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of transmission medium.

Further, it should be appreciated that modules and/or other appropriate means for performing the methods and techniques described herein can be downloaded and/or otherwise obtained by a device as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a device can obtain the various methods upon coupling or providing the storage means to the device. Moreover, any other suitable technique for providing the methods and techniques described herein to a device can be utilized.

The interfaces shown represent example implementations of a tangible device configured to perform one or more of the features described. The interface elements may be implemented via the execution of machine readable instructions to generate a graphical representation of the interface on a device. The graphical representation may be, for example, a machine readable mark-up language (e.g., HTML), executable machine readable instructions (e.g., JavaScript), or combinations of these or other display technologies. In some implementations, the interface may be constructed of physical components such as buttons, circuits, lights, and the like. The interface components may be controlled by a circuit configured to implement the methods described above. In some implementations, it may be desirable to control the interface components via a processor configured to execute stored instructions which cause the interface components to perform aspects of the methods described.

As used herein, the terms “display” or “displaying” encompass a variety of actions. For example, “displaying” may include presenting in audio form, visual form, or some other form that can be made known to the senses. The term may also include a combination of two or more of the foregoing.

As used herein, the terms “determine” or “determining” encompass a variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

As used herein, the terms “provide” or “providing” encompass a wide variety of actions. For example, “providing” may include storing a value in a location for subsequent retrieval, transmitting a value directly to the recipient, transmitting or storing a reference to a value, and the like. “Providing” may also include encoding, decoding, encrypting, decrypting, validating, verifying, and the like.

It is to be understood that the claims are not limited to the precise configuration and components illustrated above. Various modifications, changes and variations may be made in the arrangement, operation and details of the methods and apparatus described above without departing from the scope of the claims.

While the foregoing is directed to aspects of the present disclosure, other and further aspects of the disclosure may be devised without departing from the basic scope thereof, and the scope thereof is determined by the claims that follow.

1.-20. (canceled)

21. A computer-implemented method of reserving real estate listings for trial occupancy, comprising:
providing at least one real estate for sale listing to a plurality of potential buyers;
allowing at least one potential buyer to request a trial occupancy of the at least one real estate for sale listing from a seller;
enabling the seller to configure a trial occupancy profile and permit trial occupancy of the real estate for sale listing in response to the at least one potential buyer request;
permitting the plurality of potential buyers to transmit an offer for trial occupancy to seller;
reserving the real estate for sale listing in response to the offer satisfying an acceptance policy.

22. The method of claim 21, wherein the trial occupancy profile comprises one or more of an availability dates, a trial occupancy fee, a residence profile, a cleaning fee, an amenities profile, and an occupancy profile.

23. The method of claim 21, wherein the acceptance policy is satisfied in response to the offer containing agreement to one or more availability dates, a trial occupancy fee, a cleaning fee, a cancellation policy, and a least one limitations or exclusions.

24. The method of claim 21, wherein the offer comprising: an occupancy date range, a payment method and agreement to the acceptance policy.

25. The method of claim 21, wherein the real estate for sale listing is a description of a real estate listed for sale maintained in a datastore acquired from a multiple listing service syndicator.

26. The method of claim 21, wherein reserving the real estate for sale listing for the occupancy date range in response to the offer satisfying an acceptance policy is completed prior to a real estate purchase contract.

27. A computer-implemented method of reserving real estate listings for trial occupancy, comprising:
identifying a real estate for sale listing offering a trial occupancy,
wherein a seller of the real estate sale listing previously provided consent to publish the real estate for sale listing as a trial occupancy;
transmitting an offer for the trial occupancy to the seller of the real estate for sale listing;
receiving an response to the offer for the trial occupancy from the seller of the real estate for sale listing in response to the offer satisfying an acceptance policy.

28. The method of claim 27, wherein the trial occupancy comprises one or more of an availability dates, a trial occupancy fee, a residence profile, a cleaning fee, an amenities profile, and an occupancy profile.

29. The method of claim 27, wherein the acceptance policy is satisfied in response to the offer containing agreement to one or more availability dates, a trial occupancy fee, a cleaning fee, a cancellation policy, and a least one limitations or exclusions.

30. The method of claim 27, wherein the offer f comprises: a date range, a payment method and agreement to the acceptance policy.

31. The method of claim 27, wherein the real estate for sale listing is a description of a real estate listed for sale maintained in a datastore.

32. The method of claim 27, wherein the real estate for sale listing is a description of a real estate listed for sale maintained in a datastore acquired from a multiple listing service syndicator.

33. A communication server in communication with a datastore, comprising:
a hardware implemented listing search module configured to:
receive a search request transmitted by a user of a client device;
transmit the search request to the datastore in response to the received search request transmitted by the user of a client device;
receive a search response from the datastore in response to the search request; and
transmit the search response to the client device in response to the search response received from the datastore;
a hardware implemented reservation module configured to:
receive a trial occupancy request from the client device, the trial occupancy request comprising:
a unique identifier for a real estate listed for sale; and
transmit a trial occupancy response to the client device, the trial occupancy response containing either an acceptance or denial condition in response to the trial occupancy request received from the client device.

34. The communication server of claim 33, further comprising:
a hardware implemented transaction module configured to:
receive a transaction request from the client device;
transmit the transaction request to a third party transaction server;
receive a transaction response from the third party transaction server;
transmit the transaction response to the client device.

35. The communication server of claim 33, wherein the search request is a query for listings in the datastore enabled for trial occupancy matching a plurality of search filter selections.

36. The communication server of claim 33, wherein the search response is a list of residences enabled for trial occupancy matching a plurality of search filter selections.

37. The communication server of claim 33, wherein the trial occupancy request further comprising a request to purchase short term rental insurance at a specified price upon acceptance of the offer by the seller.

38. The communication server of claim 33, wherein the trial occupancy request further comprising an occupancy timeframe and a deposit payment.

39. The communication server of claim 33, wherein the trial occupancy response of acceptance is contingent upon a seller's subjective decision making.

40. The communication server of claim 33, wherein the trial occupancy response of acceptance is contingent upon agreement to acceptance policy, the acceptance policy comprising: an agreement to one or more availability dates, a trial occupancy fee, a cleaning fee, a cancellation fee, a cancellation policy, and at least one limitation or exclusion.
